(19) United States
(12) Patent Application Publication
(10) Pub. No.: US 2018/0093336 A1
(43) Pub. Date: Apr. 5, 2018

(54) DISASSEMBLEABLE THREADING DIE

(71) Applicants: Ernest M. Hanners, West Frankfort, IL (US); Judy A. Hanners, West Frankfort, IL (US)

(72) Inventors: Ernest M. Hanners, West Frankfort, IL (US); Judy A. Hanners, West Frankfort, IL (US)

(21) Appl. No.: 15/330,531

(22) Filed: Oct. 3, 2016

(51) Int. Cl. B23G 5/04; B23G 9/00

(52) U.S. Cl. CPC B23G 5/04; B23G 2210/08; B23G 2200/06; B23G 9/009

(57) ABSTRACT

Disclosed is a disassembleable threading die comprised of two half-threading dies held together by two bolts. The threading die can be disassembled and reassembled at any points along the length of a bolt onto which the threading die is screwed.

### BACKGROUND OF THE INVENTION

The invention described herein fits into the general category of machine tools. More particularly, the present invention is a threading die, and specifically, this invention is a threading die that can be disassembled.

It often happens that a nut being screwed onto a bolt faces an obstruction in that a portion of the bolt thread is destroyed or incorrectly aligned, and as a result the nut becomes jammed into immobility at that position in being threaded onto the bolt. In such a situation the nut cannot be used as intended to be further threaded along the bolt to its desired position. The nut must then be unscrewed from the bolt and no other nut can be properly used on the bolt until the thread of the bolt is repaired.

Normally, a threading die can be used to re-thread the damaged portion of the bolt thread by re-cutting the damaged portion of the bolt thread by the thread-cutting edges of the threading die. However, it would advantageous if the threading die could be applied to only that portion of the bolt thread that actually needed re-cutting rather than to the whole bolt.

### BRIEF DESCRIPTION OF THE INVENTION

The present invention solves the above problems by being a threading die that can be disassembled at any position on a bolt and that can be reassembled at any other position on the bolt.

The threading die is comprised of two half-threading dies which are held together by two smaller threaded bolts which hold the two half-threaded dies together to make the whole threaded die.

### BRIEF DESCRIPTION OF THE DRAWINGS

The accompanying drawings of the threading die are depicted as transparent to reveal interior detail even though in reality the die is made of opaque steel.

FIG. 1 shows a top view of the assembled threading die.

FIG. 2 shows a top view of the disassembled threading die.

FIG. 3 shows a front edge view of the assembled threading die.

FIG. 4 shows a front edge view of the disassembled threading die.

FIG. 5 shows the inside surfaces of the disassembled threading die wherein the left half-threading in FIG. 4 has been rotated 90 degrees in a clockwise fashion, and wherein the right half-threading die in FIG. 4 has been rotated 90 degrees in an anticlockwise direction.

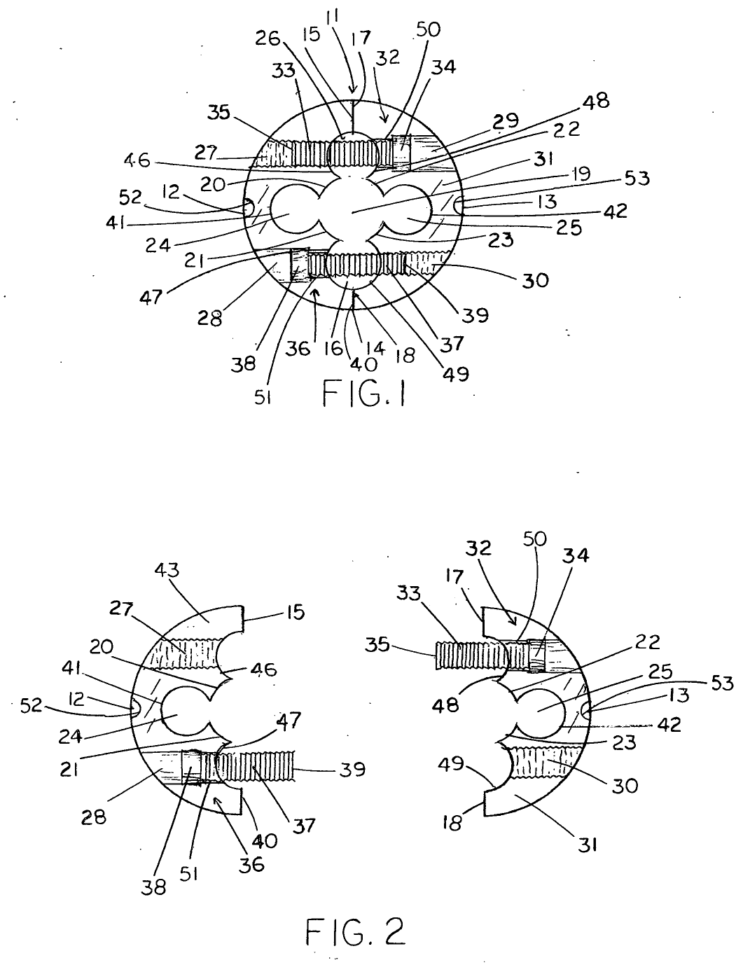

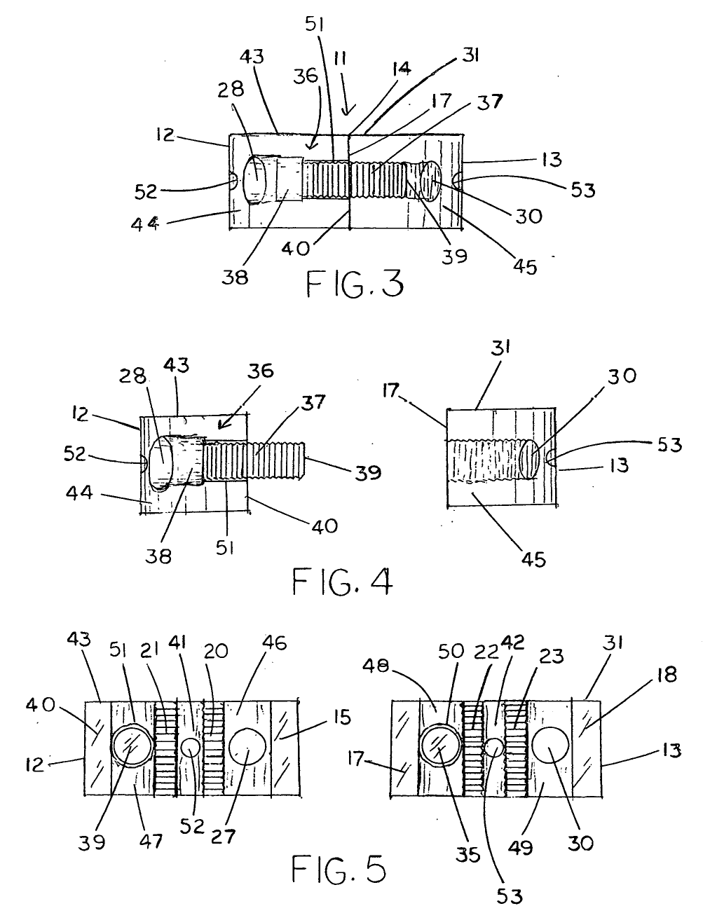

### DETAILED DESCRIPTION OF THE INVENTION

Looking at all of the figures together, it is seen that the disassembleable threading die 11 is comprised of two half-dies 12 and 13 held together by screw bolts 32 and 36. The die 11 has a top surface comprised of two half-surfaces 28 and 31, and a bottom surface not shown. The die 11 is circular in shape and bordered by the half-circular surfaces of the two half-dies as shown. The half-dies have flat interior surfaces 15 and 17, and 40 and 18, which meet at the junction 14.

The bolts 32 and 36 are comprised of circular bolt heads 34 and 38, and the bolt bodies 35 and 39. The bolt bodies have screw threads 33 and 37. The bolt heads 34 and 38 have hex wrench depressions (not shown) but could alternatively have regular screw driver depressions or Philips screw driver depressions.

The half-dies have smooth surfaced holes 29 and 28 through which the bolt heads 34 and 38 fit, and slimmer smooth surfaced holes 50 and 51 through which the bolt bodies 35 and 39 fit, and yet slimmer threaded holes 27 and 30 into which the threaded bolt bodies 35 and 39 are screwed.

Extending through the center of the die is a central large hole 19 largely bounded by the threaded partially circular surfaces 20, 21, 22, and 23. It is the central large hole 19 through which the die is intended to be screwed onto or clamped onto a large threaded bolt to which the die is applied.

The threaded partially circular surfaces 20, 21, 22, and 23, all have sharp edges that are utilized in cutting or re-cutting a good thread on a subject bolt to which the die is applied and when the die is rotated about the bolt which is being threaded or re-threaded.

The die also has extending through it four subsidiary holes 26, 25, 16, and 24, bounded by the smooth circular surfaces 48, 42, 49, and 41.

When the die is forcefully rotated about a bolt which is being threaded or rethreaded, the sharp cutting edges of the threaded cutting surfaces 20, 21, 22, and 23 cut slivers of steel from the bolt being threaded or rethreaded and such slivers of steel collect in the subsidiary holes 26, 25, 16, and 24, where the slivers are kept out of the way of the rest of a central bolt and the rest of the die.

Threading dies are typically round or hexagonal in shape. In either case, the die is used by inserting the die into a die stock well which is either round or hexagonal in shape to receive the die. The die stock has two handles which are used to forcibly rotate the die around a bolt that is being threaded. If the die has a round shape as does the die 11 depicted here, then the die will also have depressions 52 and 53 into which fit set screws from the die stock to hold the round die firmly in place.

What is claimed is:

1. A disassembleable threading die comprised of two half-threading dies held together by two or more bolts.

2. A disassembleable threading die comprised of two half-threading dies held together by two or more threaded bolts.

3. A disassembleable threading die as described in claim 2 wherein the threaded bolts have hex wrench heads.

4. A disassembleable threading die as described in claim 2 wherein the threaded bolts have regular screw driver heads.

5. A disassembleable threading die as described in claim 2 wherein the threaded bolts have Philips-screw driver heads.

6. A disassembleable threading die as described in claim 1 wherein the threading die is circular.

7. A disassembleable threading die as described in claim 2 wherein the threading die is circular.

8. A disassembleable threading die as described in claim 3 wherein the threading die is circular.

9. A disassembleable threading die as described in claim 4 wherein the threading die is circular.

10. A disassembleable threading die as described in claim 5 wherein the threading die is circular.

11. A disassembleable threading die as described in claim 1 wherein the threading die is hexagonal.

12. A disassembleable threading die as described in claim 2 wherein the threading die is hexagonal.

13. A disassembleable threading die as described in claim 3 wherein the threading die is hexagonal.

14. A disassembleable threading die as described in claim 4 wherein the threading die is hexagonal.

15. A disassembleable threading die as described in claim 5 wherein the threading die is hexagonal.
